(19) United States
(12) Patent Application Publication
(10) Pub. No.: US 2007/0113711 A1
(43) Pub. Date: May 24, 2007

(54) Ratchet wrench with a quick-rotated element which has a blocking function

(76) Inventor: Hsien-Chung Tuan Mu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/281,425

(22) Filed: Nov. 18, 2005

(51) Int. Cl. B25B 13/46

(52) U.S. Cl. 81/63.2; 81/58.1

(57) ABSTRACT

A ratchet wrench with a quick-rotated element which has a blocking function, includes a shank and a ratchet wheel pivotally received in one end of the shank. The ratchet wheel includes a polygonal hole centrally and longitudinally defined therein. The polygonal hole extends through the ratchet wheel. An annular groove is laterally defined in an inner periphery of the polygonal hole. A disk is attached to a top of the ratchet wheel and has a through hole defined therein. The through hole has a diameter smaller than that of the polygonal hole. A retainer partially is received in the annular groove in the ratchet wheel, wherein the retainer is adapted to position a tool bit that is partially and longitudinally received in the polygonal hole.

### BACKGROUND OF THE INVENTION

1. Field of the Invention

The present invention relates to a ratchet wrench, and more particularly to a ratchet wrench with a quick-rotated element which has a blocking function.

2. Description of Related Art

A conventional ratchet wrench in accordance with the prior art shown in FIG. 8 comprises a shank (80) having a through hole (81) defined in an enlarged end of the shank (80). A cavity (82) is defined in the enlarged end of the shank (80) and laterally communicates with the through hole (81). A wrench wheel (83) is rotatably received in the through hole (81) and has a polygonal hole (831) centrally defined therein and extending through the wrench wheel (83) for partially receiving a tool bit and driving the tool bit. The wrench wheel (83) has a flange (832) radially and integrally extending from an upper portion thereof. The flange (832) has a diameter greater than that of the enlarged end of the shank (80) such that the operator can quickly rotate the ratchet wheel (83) via the flange (832). A pawl (84) is mounted in the cavity (82) and selectively engaged to the ratchet wheel (83) for deciding the operating direction of the ratchet wheel (83). A direction control member (85) mounted to the enlarged end of the shank (80) for driving the pawl (84). As described above, the user can quickly rotate the ratchet wheel (83) via the flange (832) for shortening the operating time. However, the flange (832) is integrally formed with the ratchet wheel (83) such that much material is wasted when forming the ratchet wheel (83) with the flange (832). Consequently, the manufacturing cost is raised.

Another conventional ratchet wrench in accordance with the prior art shown in FIG. 9 comprises a shank (90) having a through hole (91) defined in an enlarged end of the shank (90). A cavity (92) is defined in the enlarged end of the shank (90) and laterally communicates with the through hole (91). A wrench wheel (93) is rotatably received in the through hole (91) and has a polygonal hole (931) centrally defined therein and extending through the wrench wheel (93) for partially receiving a tool bit and driving the tool bit. A ring (94) with a flange is securely mounted to an upper portion of the ratchet wheel (93) and a pawl (95) is mounted in the cavity (92) for deciding the operating direction of the ratchet wheel (93). The ring (94) with the flange is provided to solving the disadvantage of the above conventional ratchet wrench. However, the ratchet wheel (93) provides no blocking function for the tool bit such that the tool bit may be detached from the ratchet wheel (93) during operating. It is very inconvenient.

The present invention has arisen to mitigate and/or obviate the disadvantages of the two conventional ratchet wrenches.

### SUMMARY OF THE INVENTION

The main objective of the present invention is to provide an improved ratchet wrench with a quick-rotated element which provides a blocking function.

To achieve the objective, the ratchet wrench in accordance with the present invention comprises a shank and a ratchet wheel pivotally received in one end of the shank. The ratchet wheel includes a polygonal hole centrally and longitudinally defined therein. The polygonal hole extends through the ratchet wheel. An annular groove is laterally defined in an inner periphery of the polygonal hole. A disk is attached to a top of the ratchet wheel and has a through hole defined therein. The through hole has a diameter smaller than that of the polygonal hole. A retainer partially is received in the annular groove in the ratchet wheel, wherein the retainer is adapted to position a tool bit that is partially and longitudinally received in the polygonal hole.

Further benefits and advantages of the present invention will become apparent after a careful reading of the detailed description with appropriate reference to the accompanying drawings.

### BRIEF DESCRIPTION OF THE DRAWINGS

FIG. 1 is a first schematic perspective view of a ratchet wrench with a quick-rotated element which has a blocking function in accordance with the present invention;

FIG. 2 is an exploded perspective view of the ratchet wrench in FIG. 1;

FIG. 3 is a cross-sectional view of the ratchet wrench in FIG. 1;

FIG. 4 is an exploded perspective view of a second embodiment of the ratchet wrench in accordance with the present invention;

FIG. 5 is a cross-sectional view of the second embodiment of the ratchet wrench in accordance with the present invention;

FIG. 6 is an operational view of the ratchet wrench of the present invention;

FIG. 7 is a schematic view of the ratchet wrench of the present invention when the tool bit is detached from the ratchet wheel of the present invention;

FIG. 8 is an exploded perspective view of a first conventional ratchet wrench in accordance with the prior art; and

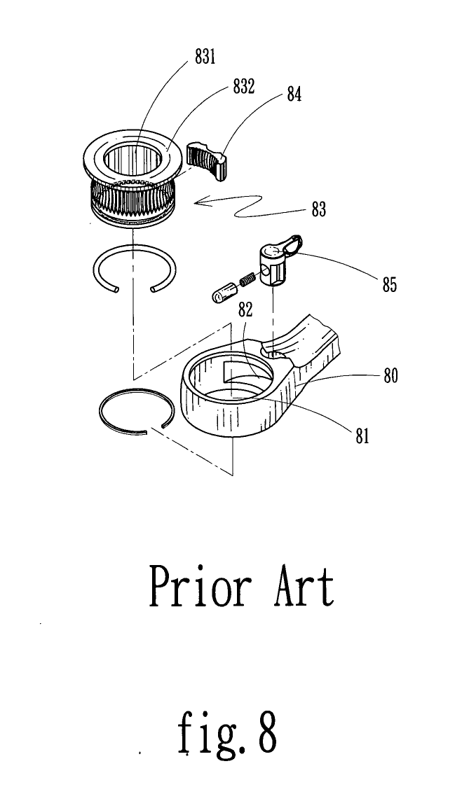

FIG. 9 is an exploded perspective view of a second conventional ratchet wrench in accordance with the prior art.

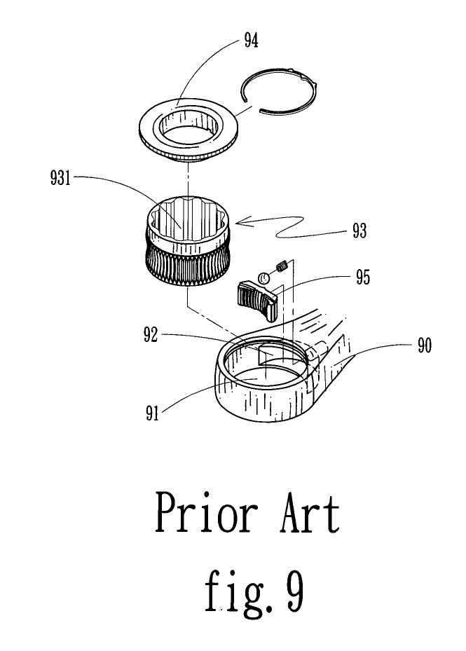

### DETAILED DESCRIPTION OF THE INVENTION

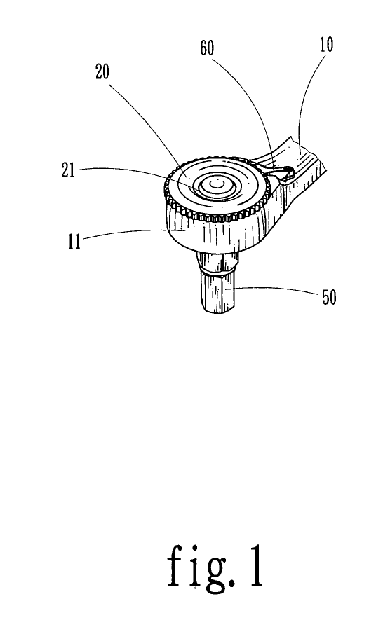

Referring to the drawings and initially to FIGS. 1-3, a ratchet wrench in accordance with the present invention comprises a shank (10) has an enlarge end (11) formed on one end of the shank (10). A through hole (100) is defined in the enlarge end (11) and a first annular groove (110) defined in an inner periphery of the through hole (100). A ratchet wheel (12) is pivotally received in the through hole (100) and has a first protrusion (121) longitudinally extending from an upper end of the ratchet wheel (12). A polygonal hole (120) is centrally defined in the ratchet wheel (12) and extends through the ratchet wheel (12). A second annular groove (122) is defined in an inner periphery of the polygonal hole (120) under a middle section of the ratchet wheel (12) for receiving a retainer (30).

A disk (20) is mounted to the upper end of the ratchet wheel (12) and has a through hole (21) centrally defined therein. The through hole (21) in the disk (20) has a diameter smaller than that of the polygonal hole (120). The disk (20) has a second protrusion (22) extending from a bottom thereof and securely sleeved on the first protrusion (121) of the ratchet wheel (12) to hold the disk (20) in place. The disk (20) has a diameter greater than that of the enlarged end (11) of the shank (10) such that the operator can quickly drive the ratchet wheel (12) by rotating the disk (20) to shorten the operating time.

A C-shaped ring (40) is received in the first annular groove (110).

A tool bit (50) is inserted into the polygonal hole (121) for driving a fastener (not shown). The tool bit (50) has a third annular groove (51) laterally defined in an outer periphery of the tool bit (50).

A direction control unit (60) is mounted in the enlarged end (11) for controlling the operating direction of the ratchet wheel (12).

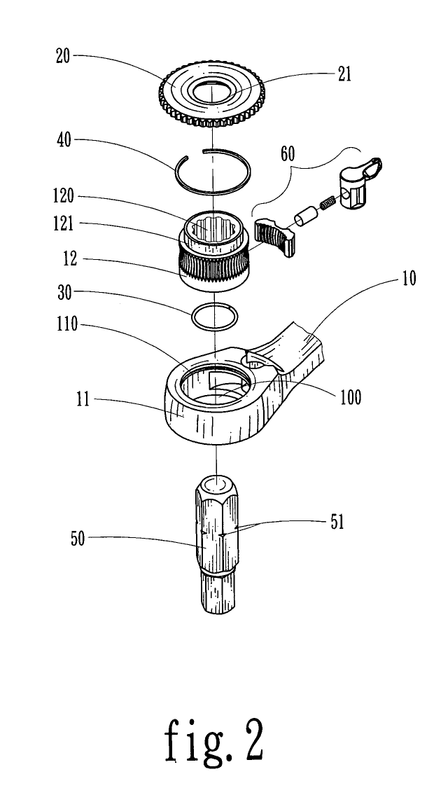

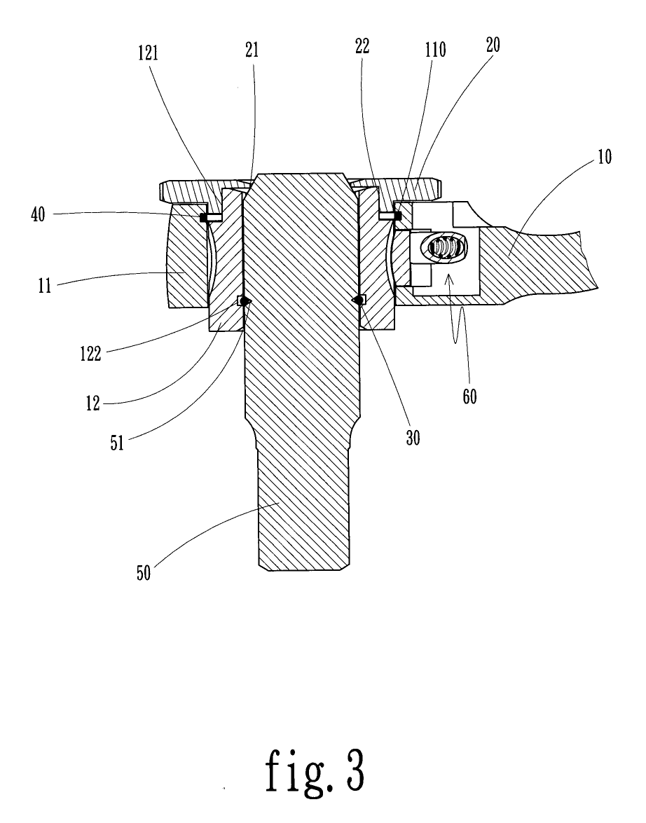

With reference to FIGS. 2 and 3, the ratchet wheel (12) and the C-shaped ring (40) are respectively disposed in the through hole (100) and the first annular groove (110), wherein the ratchet wheel (12) upwardly engaged to the C-shaped ring (40) and the first protrusion (121) extends over a top of the enlarged end (11). The second protrusion (22) of the disk (20) is securely sleeved on the first protrusion (121) of the ratchet wheel (12) such that the disk (20) and the C-shaped ring (40) are provided to prevent the ratchet wheel (12) from detaching from the enlarged end (11). The retainer (30) is partially received in the third annular groove (51) to position the tool bit (50) when the tool bit (50) in inserted into the polygonal hole (120) and the top of the tool bit (50) abuts a periphery of the through hole (21) in the disk (20) to prevent the tool bit (50) from overly extending through the ratchet wheel (12).

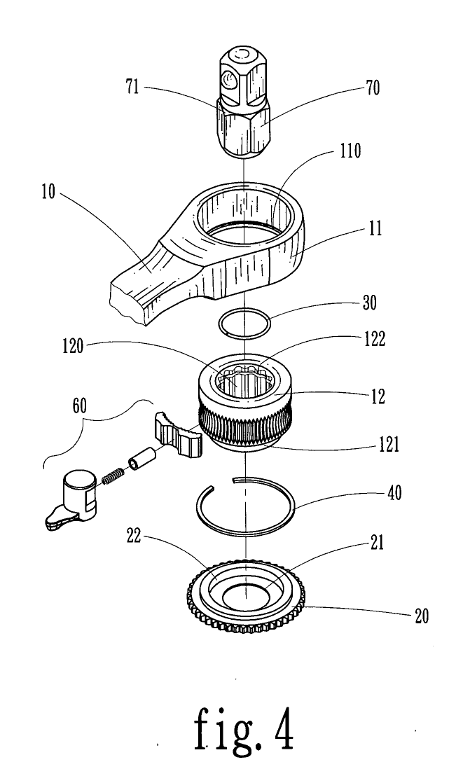

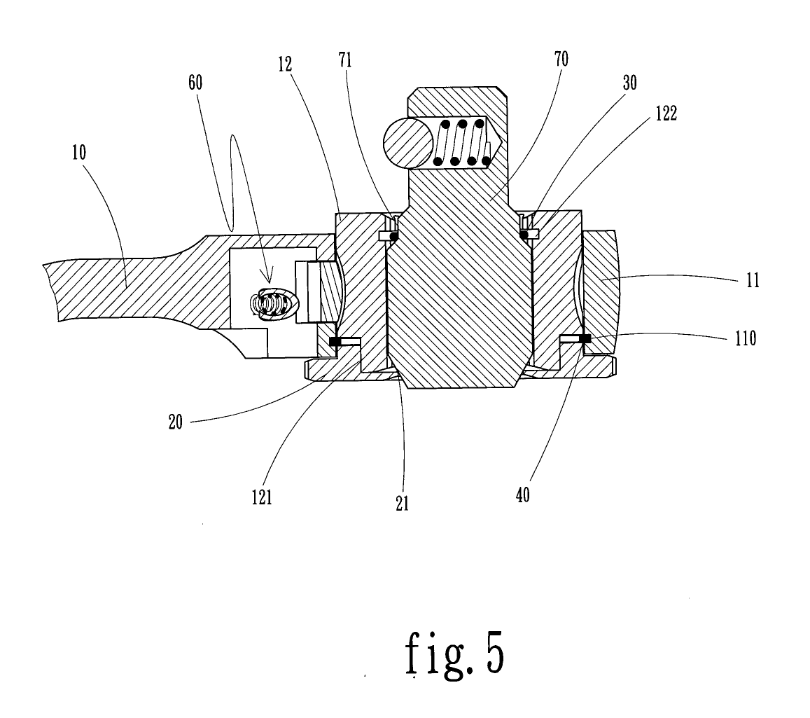

With reference to FIGS. 4 and 5 that show a second schematic embodiment of the present invention, the ratchet wheel (12) and the C-shaped ring (40) are respectively disposed in the through hole (100) and the first annular groove (110), wherein the ratchet wheel (12) upwardly engaged to the C-shaped ring (40) and the first protrusion (121) extends over a top of the enlarged end (11). The second protrusion (22) of the disk (20) is securely sleeved on the first protrusion (121) of the ratchet wheel (12) such that the disk (20) and the C-shaped ring (40) are provided to prevent the ratchet wheel (12) from detaching from the enlarged end (11). A second tool bit (70) is inserted into the polygonal hole (121). The second tool bit (70) has a shoulder (71) formed near a middle section thereof. The retainer (30) holds the shoulder (71) of the second tool bit (70) to position the second tool bit (70) when the tool bit (50) in inserted into the polygonal hole (120) and the top of the second tool bit (70) abuts a periphery of the through hole (21) in the disk (20) to prevent the second tool bit (70) from overly extending through the ratchet wheel (12).

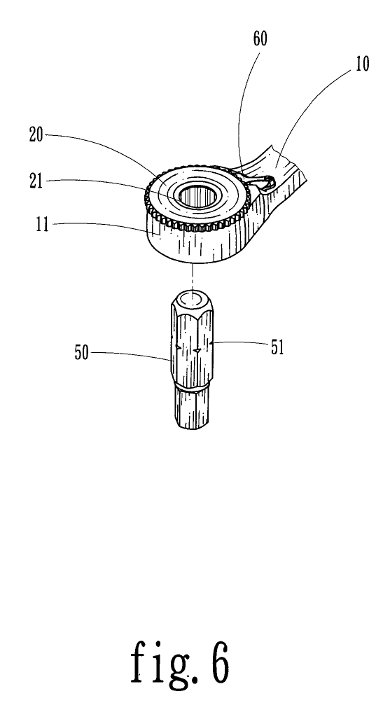

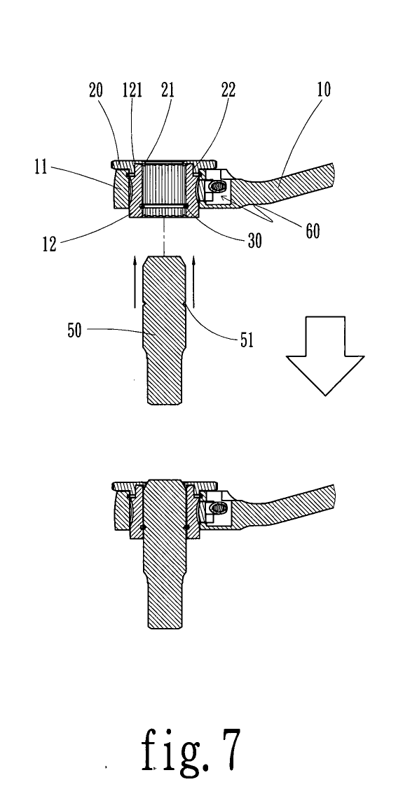

With reference to FIGS. 6 and 7, the retainer (30) is outwardly opened when the tool bit (50) inserted into the polygonal hole (120) in the ratchet wheel (12). The retainer (30) immediately shrinks to be partially received in the third annular groove (51) to position the tool bit (50) when the third annular groove (51) horizontally corresponds to the retainer (30). In addition, the top of the tool bit (50) abuts the periphery of the through hole (21) in the disk (20) such that the tool bit (50) is stably positioned between the ratchet wheel (12) and the disk (20).

Although the invention has been explained in relation to its preferred embodiment, it is to be understood that many other possible modifications and variations can be made without departing from the spirit and scope of the invention as hereinafter claimed.

1. A ratchet wrench with a quick-rotated element which has a blocking function, comprising:
a shank and a ratchet wheel rotatably received in one end of the shank, the ratchet wheel including a polygonal hole centrally and longitudinally defined therein, the polygonal hole extending through the ratchet wheel, an annular groove laterally defined in an inner periphery of the polygonal hole;
a separably formed disk attached to a top of the ratchet wheel and having an axial bore extending therein, the disk having an annular upper surface projecting radially inward into the axial bore to define a through hole having a diameter smaller than the polygonal hole; and
a retainer partially received in the annular groove in the ratchet wheel, the retainer adapted to position a tool bit that is partially and longitudinally received in the polygonal hole, the tool bit having a top abutting a periphery of the through hole in the disk such that the tool bit is stably positioned between the ratchet wheel and the disk;
wherein the ratchet wheel has a first protrusion longitudinally extending from a top rim surface thereof for insert into the axial bore of the disk, and the disk has a second protrusion extending from a bottom about the axial bore, the second protrusion being securely sleeved about the first protrusion and spaced from the top rim surface of the ratchet wheel to define a retaining space within the end of the shank.

2. (canceled)

3. The ratchet wrench as claimed in claim 1, wherein the annular groove is defined under a middle section of the ratchet wheel.

4. The ratchet wrench as claimed in claim 1, wherein the through hole in the disk is centrally defined in the disk.

5. The ratchet wrench as claimed in claim 1, wherein the second protrusion centrally extends from the bottom of the disk.

6. The ratchet wrench as claimed in claim 1 further comprising a direction control unit mounted in the end of the shank for controlling the operating direction of the ratchet wheel.

7. The ratchet wrench as claimed in claim 1 wherein the first protrusion of the ratchet wheel terminates at an annular end including a surface tapered radially inward.

8. The ratchet wrench as claimed in claim 7 wherein an inner peripheral portion of the disk disposed substantially above the annular end of the first protrusion includes a surface tapered radially inward to the through hole.
